(19) United States
(12) Patent Application Publication
(10) Pub. No.: US 2021/0279774 A1
(43) Pub. Date: Sep. 9, 2021

(54) SYSTEMS AND METHODS FOR DYNAMIC CAMPAIGN ENGINE

(71) Applicant: Shopify Inc., Ottawa (CA)

(72) Inventors: Brooke FITZGERALD, Montréal (CA); David CORNU, Montréal (CA)

(21) Appl. No.: 16/808,934

(22) Filed: Mar. 4, 2020

(51) Int. Cl. G06Q 30/02

(52) U.S. Cl. CPC G06Q 30/0276; G06Q 30/0204; G06Q 30/0277

(57) ABSTRACT

Methods and systems for a dynamic complain engine are disclosed, the system includes: a processor in communication with a storage, the processor configured to execute instructions to cause the system to: receive, from a user account, a set of submitted campaign parameters for a proposed messaging campaign associated with an online store; determine a default set of campaign parameters for the proposed messaging campaign; when at least one parameter from the set of submitted campaign parameters is determined to exceed a corresponding parameter from the default set of campaign parameters, generate an updated set of campaign parameters based on a configuration of the online store; and generate a final set of campaign parameters for the proposed messaging campaign based on at least one of the set of submitted campaign parameters and the updated set of campaign parameters.

### FIELD

The present disclosure relates to methods and systems for generating a messaging campaign, and specifically, to a messaging campaign in e-commerce settings.

### BACKGROUND

Marketers and merchants often use messaging campaigns to communicate certain message contents to an intended group of audience. For stores having an online presence (e.g., an e-commerce store), such messaging campaigns often include messages sent via electronic channels, such as via email or social media.

Conventional techniques for generating and managing messaging campaigns (e.g., email marketing campaigns) have limited flexibility. In addition, problems may arise when a user uses a campaign generator in bad faith (such a user may be referred to as a “bad actor”) to send spam messages.

Existing approaches to blocking bad actors generally rely on a recipient of the spam message to report spam, or uses some sort of filtering based on the contents of the message. Neither approach can block the spam message from being sent in the first place. Further, such “whack-a-mole” approaches do not dissuade a bad actor from future spamming. A more intelligent approach to address such bad actors is desired.

Another problem is that a legitimate merchant might sign up for a certain subscription level or fee for a messaging campaign, which may have a defined maximum number of intended recipients for the campaign. Typically, the defined maximum number of intended recipients may be fixed per subscription level or fee, and can be adjusted only with a corresponding change in fee payment. It would be useful to provide a more flexible and intelligent way to adjust the maximum number of intended recipients (e.g., a campaign size) for a messaging campaign proposed by a merchant.

### SUMMARY

The present disclosure describes various examples which may enable more dynamic generation of messaging campaigns. In some examples, a set of recommended parameters for a messaging campaign may be automatically generated, based on a set of default parameters and/or user-submitted campaign parameters.

The examples described herein may be implemented in the context of an e-commerce platform, or may be made available for use outside of the e-commerce platform.

Some examples described herein may be described in the context of email communications. However, it should be understood that different forms of electronic communications (e.g., email, text messaging, social media private or public messages, etc.) may be within the scope of the present disclosure.

In some examples, the present disclosure describes a system including a processor in communication with a storage. The processor is configured to execute instructions in the storage to cause the system to: receive, from a user account, a set of submitted campaign parameters for a proposed messaging campaign associated with an online store; determine a default set of campaign parameters for the proposed messaging campaign; when at least one parameter from the set of submitted campaign parameters is determined to exceed a corresponding parameter from the default set of campaign parameters, generate an updated set of campaign parameters based on a configuration of the online store; and generate a final set of campaign parameters for the proposed messaging campaign based on at least one of the set of submitted campaign parameters and the updated set of campaign parameters.

In some examples, the present disclosure describes a method including: receiving, from a user account, a set of submitted campaign parameters for a proposed messaging campaign associated with an online store; determine a default set of campaign parameters for the proposed messaging campaign; when at least one parameter from the set of submitted campaign parameters is determined to exceed a corresponding parameter from the default set of campaign parameters, generating an updated set of campaign parameters based on a configuration of the online store; and generating a final set of campaign parameters for the proposed messaging campaign based on at least one of the set of submitted campaign parameters and the updated set of campaign parameters.

In some examples, the present disclosure describes a computer readable medium having computer-executable instructions stored thereon. The instructions, when executed by a processor of a system, causes the system to: receive, from a user account, a set of submitted campaign parameters for a proposed messaging campaign associated with an online store; determine a default set of campaign parameters for the proposed messaging campaign; when at least one parameter from the set of submitted campaign parameters is determined to exceed a corresponding parameter from the default set of campaign parameters, generate an updated set of campaign parameters based on a configuration of the online store; and generate a final set of campaign parameters for the proposed messaging campaign based on at least one of the set of submitted campaign parameters and the updated set of campaign parameters.

In any of the above examples, determining the default set of campaign parameters can be based on a subscription level of the user account. The subscription level can be used to determine a campaign size of the proposed messaging campaign.

In any of the above examples, the system or method can cause the processor to execute the messaging campaign based on the final set of campaign parameters.

In any of the above examples, the final set of campaign parameters may include some or all parameters from the default set of campaign parameters when none of the set of submitted campaign parameters are compliant with the default set of campaign parameters and the online store has not been configured for processing transactions.

In any of the above examples, the final set of campaign parameters may include some or all parameters from the set of submitted campaign parameters when the set of submitted campaign parameters are compliant with the default set of campaign parameters; or when one or more parameters from the set of submitted campaign parameters exceed one or more parameters from the default set of campaign parameters and the online store has been configured for processing transactions.

In any of the above examples, the final set of campaign parameters may include some or all parameters from the updated set of campaign parameters when: the set of submitted campaign parameters are compliant with the updated set of campaign parameters, the updated set of campaign parameters are generated based on a financial transaction configuration for the online store, and the online store has been configured for processing transactions.

In any of the above examples, the configuration for the online store may include at least one of: a uniform resource locator (URL) for the online store; an inventory configuration for a product offered by the online store; a delivery configuration for delivering a product offered by the online store; a product offering configuration for the online store; and a financial transaction configuration for the online store.

In any of the above examples, generating the updated set of campaign parameters may be based on a transaction history of the online store.

In any of the above examples, the final set of campaign parameters may include at least one of: a campaign distribution channel; a maximum number of recipients; an intended segment; a campaign message format; a permitted incentive inclusion; a geographical region; and a duration of a campaign.

In any of the above examples, when the at least one parameter from the set of submitted campaign parameters is determined to exceed the corresponding parameter from the default set of campaign parameters, the system or the method may: send a request to the user account to perform a task; determine that the requested task has been completed; and generate the updated set of campaign parameters based on the set of submitted campaign parameters.

In any of the above examples, the task may include at least one of: configuring the online store for processing transactions; setting up a uniform resource locator (URL) for the online store; an inventory configuration for a product offered by the online store; a setting up delivery configuration for delivering a product offered by the online store; setting up a product offering configuration for the online store; and setting up a financial transaction configuration for the online store.

### BRIEF DESCRIPTION OF THE DRAWINGS

Reference will now be made, by way of example, to the accompanying drawings which show example embodiments of the present application, and in which:

FIG. 1 is a block diagram of an example e-commerce platform, in which examples described herein may be implemented;

FIG. 2 is an example homepage of an administrator, which may be accessed via the e-commerce platform of FIG. 1;

FIG. 3 is another block diagram of the e-commerce platform of FIG. 1, showing some details related to application development;

FIG. 4 shows an example data flow that may take place when a purchase is made using the e-commerce platform of FIG. 1;

FIG. 5 is a block diagram illustrating an example implementation of the e-commerce platform of FIG. 1;

FIG. 6 is another block diagram of the e-commerce platform of FIG. 1, showing some details related to a dynamic campaign engine; and

FIG. 7 is a flowchart illustrating an example method for generating a messaging campaign.

Similar reference numerals may have been used in different figures to denote similar components.

### DESCRIPTION OF EXAMPLE EMBODIMENTS

The present disclosure will be described in the context of an e-commerce platform, discussed below. However, it should be understood that this discussion is only for the purpose of illustration and is not intended to be limiting. Further, it should be understood that the present disclosure may be implemented in other contexts, and is not necessarily limited to implementation in an e-commerce platform.

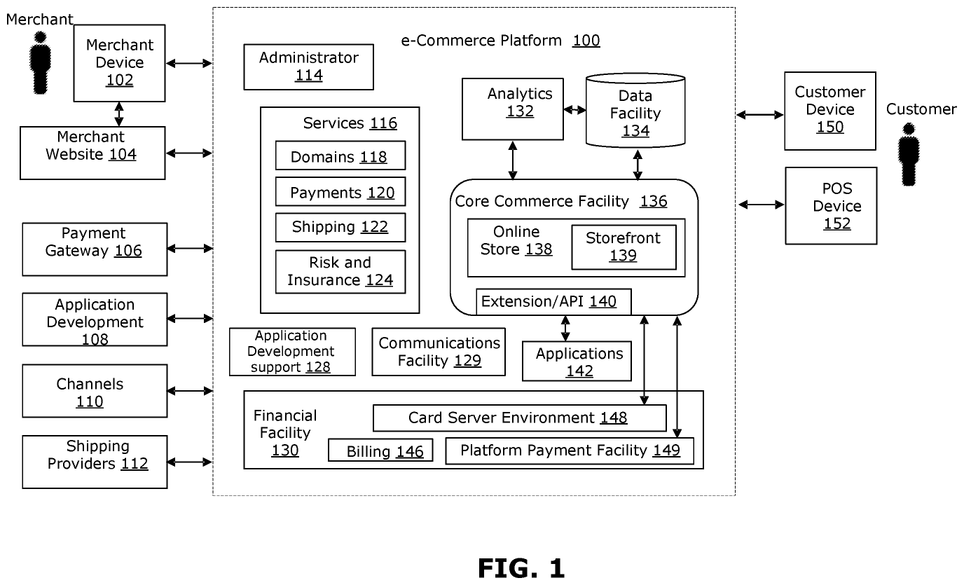

With reference to FIG. 1, an embodiment e-commerce platform 100 is depicted for providing merchant products and services to customers. While the disclosure throughout contemplates using the apparatus, system, and process disclosed to purchase products and services, for simplicity the description herein will refer to products or offerings. All references to products or offerings throughout this disclosure should also be understood to be references to products and/or services, including physical products, digital content, tickets, subscriptions, services to be provided, and the like.

While the disclosure throughout contemplates that a “merchant”, a “marketer” and a “customer” may be more than individuals, for simplicity the description herein may generally refer to merchants, marketers and customers as such. All references to merchants, marketers and customers throughout this disclosure should also be understood to be references to groups of individuals, companies, corporations, computing entities, and the like, and may represent for-profit or not-for-profit exchange of products. Further, while the disclosure throughout refers to “merchants”, “marketers” and “customers”, and describes their roles as such, it should be understood that aspects of the e-commerce platform 100 may be more generally available to support users in an e-commerce environment, and all references to merchants, marketers and customers throughout this disclosure should also be understood to be references to users, such as where a user is a merchant-user (e.g., a seller, retailer, wholesaler, or provider of products), a marketer-user (e.g., a marketing agent, an external marketing service provider, or a self-marketing merchant), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Further, it should be understood that any individual or group of individuals may play more than one role and may fit more than one label in the e-commerce environment. For example, a merchant may also be a marketer, or a corporate user may also be a customer.

The e-commerce platform 100 may provide a centralized system for providing merchants with online resources for managing their business. Merchants may utilize the e-commerce platform 100 for managing commerce with customers, such as by implementing an e-commerce experience with customers through an online store 138, through channels 110, through point of sale (POS) devices 152 in physical locations (e.g., a physical storefront or other location such as through a kiosk, terminal, reader, printer, 3D printer, and the like), by managing their business through the e-commerce platform 100, by interacting with customers through a communications facility 129 of the e-commerce platform 100, or any combination thereof.

The online store 138 may represent a multitenant facility comprising a plurality of virtual storefronts 139. In various embodiments, merchants may manage one or more storefronts 139 in the online store 138, such as through a merchant device 102 (e.g., computer, laptop computer, mobile computing device, and the like), and offer products to customers through a number of different channels 110 (e.g., an online store 138; a physical storefront through a POS device 152; electronic marketplace, through an electronic buy button integrated into a website or social media channel such as on a social network, social media page, social media messaging system; and the like). A merchant may sell across channels 110 and then manage their sales through the e-commerce platform 100. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront 139 through the online store 138, and utilizing the communications facility 129 to leverage customer interactions and analytics 132 to improve the probability of sales, for example.

In various embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication, and the like, providing a system for reaching customers and facilitating merchant services for the real or virtual pathways available for reaching and interacting with customers.

In various embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application development 108, channels 110, shipping providers 112, customer devices 150, POS devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a thin client via a web browser, accessed through by POS devices, and the like). In various embodiments, elements of the e-commerce platform 100 may be implemented to operate on various platforms and operating systems, such as iOS, Android, over the internet, and the like.

In various embodiments, storefronts 139 may be served by the e-commerce platform 100 to customers (e.g., via customer devices 150), where customers can browse and purchase the various products available (e.g., add them to a cart, purchase immediately through a buy-button, and the like). Storefronts 139 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their storefront 139. Merchants may customize the look and feel of their website through a theme system, such as where merchants can select and change the look and feel of their storefront 139 by changing their theme while having the same underlying product and business data shown within the storefront's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a basic content management system for website content. Merchants may author blog posts or static pages and publish them to their storefront 139 and/or website 104, such as through blogs, articles, and the like, as well as configure navigation menus. Merchants may upload images (e.g., for products), video, content, data, and the like to the e-commerce platform 100, such as for storage by the system. In various embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110, including the online store 138, over the telephone, as well as through physical POS devices 152 as described herein. The e-commerce platform 100 may provide business support services 116, an administrator component 114, and the like associated with running an online business, such as providing a domain service 118 associated with their online store, payments services 120 for facilitating transactions with a customer, shipping services 122 for providing customer shipping options for purchased products, risk and insurance services 124 associated with product protection and liability, merchant billing services 146, and the like. Services 116 may be provided via the e-commerce platform 100 or in association with external facilities, such as through a payment gateway 106 for payment processing, shipping providers 112 for expediting the shipment of products, and the like.

In various embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

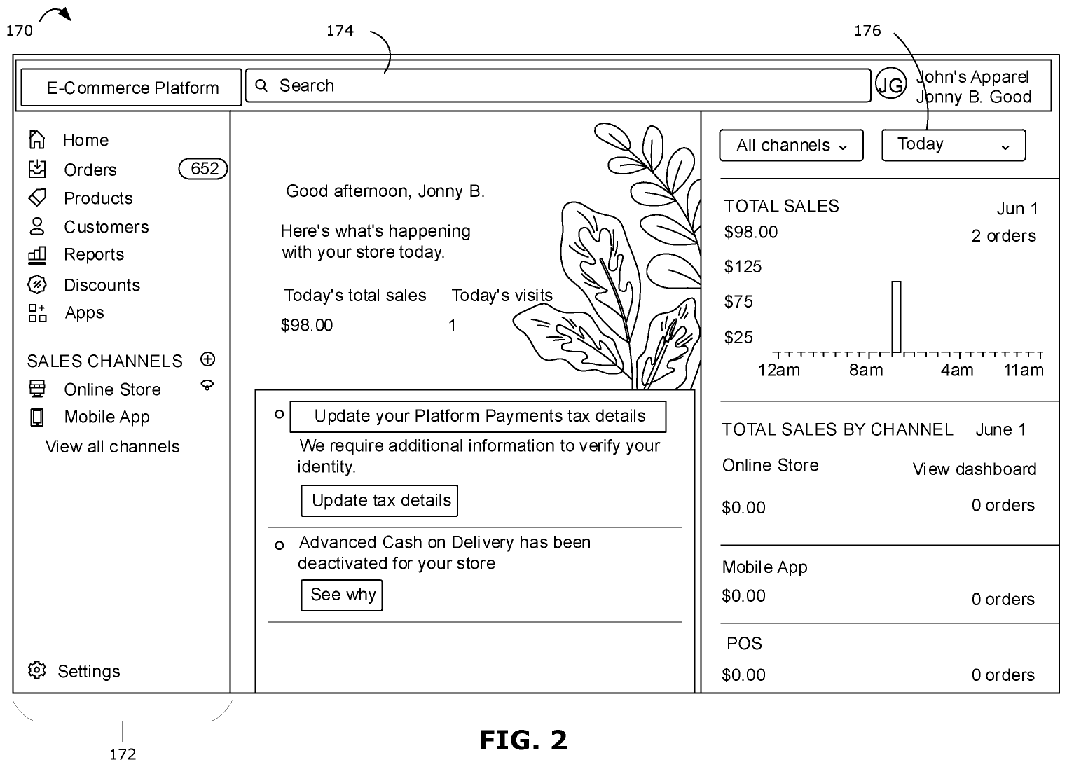

FIG. 2 depicts a non-limiting embodiment for a home page 170 of an administrator 114, which may show information about daily tasks, a store's recent activity, and the next steps a merchant can take to build their business. In various embodiments, a merchant may log in to administrator 114, such as from a browser or mobile device, and manage aspects of their storefront, such as viewing the storefront's recent activity, updating the storefront's catalog, managing orders, recent visits activity, total orders activity, and the like. In various embodiments, the merchant may be able to access the different sections of administrator 114 by using the sidebar 172, such as shown on FIG. 2. Sections of the administrator may include core aspects of a merchant's business, including orders, products, and customers; sales channels, including the online store, POS, and buy button; applications installed on the merchant's account; settings applied to a merchant's storefront 139 and account. A merchant may use a search bar 174 to find products, pages, or other information. Depending on the device the merchant is using, they may be enabled for different functionality through the administrator 114. For instance, if a merchant logs in to the administrator 114 from a browser, they may be able to manage all aspects of their storefront 139. If the merchant logs in from their mobile device, they may be able to view all or a subset of the aspects of their storefront 139, such as viewing the storefront's recent activity, updating the storefront's catalog, managing orders, and the like.

More detailed information about commerce and visitors to a merchant's storefront 139 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110 from different periods of time (e.g., days, weeks, months, and the like), such as by using drop-down menus 176. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's storefront 139, such as based on account status, growth, recent customer activity, and the like. Notifications may be provided to assist a merchant with navigating through a process, such as capturing a payment, marking an order as fulfilled, archiving an order that is complete, and the like.

Reference is made back to FIG. 1. The e-commerce platform may provide for a communications facility 129 and associated merchant interface for providing electronic communications and marketing, such as utilizing an electronic messaging aggregation facility (not shown) for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 130 for secure financial transactions with customers, such as through a secure card server environment 148. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 130 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In various embodiments, online store 138 may support a great number of independently administered storefronts 139 and process a large volume of transactional data on a daily basis for a variety of products. Transactional data may include customer contact information, billing information, shipping information, information on products purchased, information on services rendered, and any other information associated with business through the e-commerce platform 100. In various embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

In various embodiments, the e-commerce platform 100 may be configured with a core commerce facility 136 for content management and task automation to enable support and services to the plurality of storefronts 139 (e.g., related to products, inventory, customers, orders, collaboration, suppliers, reports, financials, risk and fraud, and the like), but be extensible through applications 142 that enable greater flexibility and custom processes required for accommodating an ever-growing variety of merchant storefronts 139, POS devices 152, products, and services. For instance, the core commerce facility 136 may be configured for flexibility and scalability through portioning (e.g., sharding) of functions and data, such as by customer identifier, order identifier, storefront identifier, and the like. The core commerce facility 136 may accommodate store-specific business logic and a web administrator. The online store 138 may represent a channel, be embedded within the core commerce facility 136, provide a set of support and debug tools that support uses for merchants, and the like. The core commerce facility 136 may provide centralized management of critical data for storefronts 139.

The core commerce facility 136 includes base or “core” functions of the e-commerce platform 100, and as such, as described herein, not all functions supporting storefronts 139 may be appropriate for inclusion. For instance, functions for inclusion into the core commerce facility 136 may need to exceed a core functionality threshold through which it may be determined that the function is core to a commerce experience (e.g., common to a majority of storefront activity, such as across channels, administrator interfaces, merchant locations, industries, product types, and the like), is re-usable across storefronts (e.g., functions that can be re-used/modified across core functions), limited to the context of a single storefront at a time (e.g., implementing a storefront ‘isolation principle’, where code should not be able to interact with multiple storefronts at a time, ensuring that storefronts cannot access each other's data), provide a transactional workload, and the like. Maintaining control of what functions are implemented may enable the core commerce facility 136 to remain responsive, as many required features are either served directly by the core commerce facility 136 or enabled by its extension/application programming interface (API) 140 connection to applications 142. If care is not given to restricting functionality in the core commerce facility 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the core commerce facility 136 may be configured to maintain responsiveness, such as through configuration that utilizes timeouts, queues, back-pressure to prevent degradation, and the like.

Although isolating storefront data is important to maintaining data privacy between storefronts 139 and merchants, there may be reasons for collecting and using cross-store data, such as for example, with an order risk assessment system or a platform payment facility, both of which require information from a majority of storefronts 139 to perform well. In various embodiments, rather than violating the isolation principle, it may be preferred to move these components out of the core commerce facility 136 and into their own infrastructure within the e-commerce platform 100. For example, the data facility 134 and analytics 132 may be located outside the core commerce facility 136.

In various embodiments, the e-commerce platform 100 may provide for a platform payment facility 149, which is another example of a component that utilizes data from the core commerce facility 138 but may be located outside so as to not violate the isolation principle. The platform payment facility 149 may allow customers interacting with storefronts 139 to have their payment information stored safely by the core commerce facility 136 such that they only have to enter it once. When a customer visits a different storefront 139, even if they've never been there before, the platform payment facility 149 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from a storefront's checkout, allowing information to be made available globally across storefronts 139. It would be difficult and error prone for each storefront 139 to be able to connect to any other storefront 139 to directly retrieve the payment information stored there. As a result, the platform payment facility 149 may be implemented external to the core commerce facility 136.

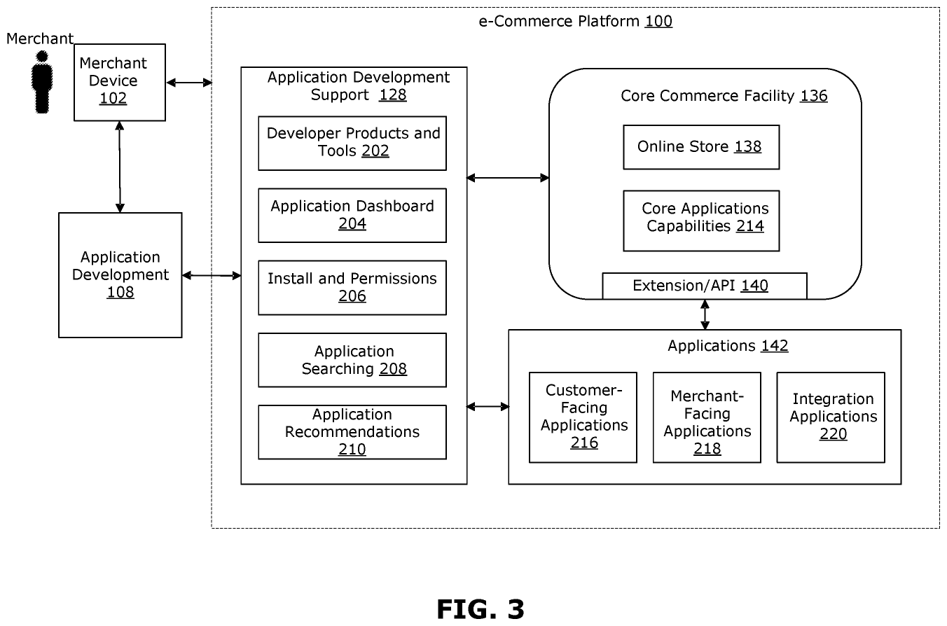

For those functions that are not included within the core commerce facility 138, applications 142 provide a way to add features to the e-commerce platform 100. Applications 142 may be able to access and modify data on a merchant's storefront 139, perform tasks through the administrator 114, create new flows for a merchant through a user interface (e.g., that is surfaced through extensions/API 140), and the like. Merchants may be enabled to discover and install applications 142 through application searching 208 and application recommendations 210 (see FIG. 3). In various embodiments, core products, core extension points, applications, and the administrator 114 may be developed to work together. For instance, application extension points may be built inside the administrator 114 so that core features may be extended by way of applications 142, which may deliver functionality to a merchant through the extension/API 140.

In various embodiments, applications 142 may deliver functionality to a merchant through the extension/API 140, such as where an application 142 is able to surface transaction data to a merchant (e.g., App: “Surface my app in mobile and web admin using the embedded app SDK”), and/or where the core commerce facility 136 is able to ask the application to perform work on demand (core: “App, give me a local tax calculation for this checkout”).

Applications 142 may support storefronts 139 and channels 110, provide merchant support, integrate with other services, and the like. Where the core commerce facility 136 may provide the foundation of services to the storefront 139, the applications 142 may provide a way for merchants to satisfy specific and sometimes unique needs. Different merchants will have different needs, and so may benefit from different applications 142. Applications 142 may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142 may be connected to the core commerce facility 136 through an extension/API layer 140, such as utilizing APIs to expose the functionality and data available through and within the core commerce facility 136 to the functionality of applications (e.g., through REST, GraphQL, and the like). For instance, the e-commerce platform 100 may provide API interfaces to merchant and partner-facing products and services, such as including application extensions, process flow services, developer-facing resources, and the like. With customers more frequently using mobile devices for shopping, applications 142 related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the core commerce facility 136, thus providing merchants what they need when they need it. For instance, shipping services 122 may be integrated with the core commerce facility 136 through a shipping or carrier service API, thus enabling the e-commerce platform 100 to provide shipping service functionality without directly impacting code running in the core commerce facility 136.

Many merchant problems may be solved by letting partners improve and extend merchant workflows through application development, such as problems associated with back-office operations (merchant-facing applications) and in the storefront (customer-facing applications). As a part of doing business, many merchants will use mobile and web related applications on a daily basis for back-office tasks (e.g., merchandising, inventory, discounts, fulfillment, and the like) and storefront tasks (e.g., applications related to their online shop, for flash-sales, new product offerings, and the like), where applications 142, through extension/API 140, help make products easy to view and purchase in a fast growing marketplace. In various embodiments, partners, application developers, internal applications facilities, and the like, may be provided with a software development kit (SDK), such as through creating a frame within the administrator 114 that sandboxes an application interface. In various embodiments, the administrator 114 may not have control over nor be aware of what happens within the frame. The SDK may be used in conjunction with a user interface kit to produce interfaces that mimic the look and feel of the e-commerce platform 100, such as acting as an extension of the core commerce facility 136.

Applications 142 that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the core commerce facility 136, such as for synchronizing a local database, notifying an external integration partner, and the like. Update events may enable this functionality without having to poll the core commerce facility 136 all the time to check for updates, such as through an update event subscription. In various embodiments, when a change related to an update event subscription occurs, the core commerce facility 136 may post a request, such as to a predefined callback URL. The body of this request may contain a new state of the object and a description of the action or event. Update event subscriptions may be created manually, in the administrator facility 114, or automatically (e.g., via the API). In various embodiments, update events may be queued and processed asynchronously from a state change that triggered them, which may produce an update event notification that is not distributed in real-time.

Reference is made to FIG. 3, which is another depiction of the e-commerce platform 100. FIG. 3 omits some details that have been described with reference to FIG. 1, and shows further details discussed below. In various embodiments, the e-commerce platform 100 may provide application development support 128. Application development support 128 may include developer products and tools 202 to aid in the development of applications, an application dashboard 204 (e.g., to provide developers with a development interface, to administrators for management of applications, to merchants for customization of applications, and the like), facilities for installing and providing permissions 206 with respect to providing access to an application 142 (e.g., for public access, such as where criteria must be met before being installed, or for private use by a merchant), application searching 208 to make it easy for a merchant to search for applications 142 that satisfy a need for their storefront 139, application recommendations 210 to provide merchants with suggestions on how they can improve the user experience through their storefront 139, a description of core application capabilities 214 within the core commerce facility 136, and the like. These support facilities may be utilized by application development 108 performed by any entity, including the merchant developing their own application 142, a third-party developer developing an application 142 (e.g., contracted by a merchant, developed on their own to offer to the public, contracted for use in association with the e-commerce platform 100, and the like), or an application being developed by internal personal resources associated with the e-commerce platform 100. In various embodiments, applications 142 may be assigned an application identifier (ID), such as for linking to an application (e.g., through an API), searching for an application, making application recommendations, and the like.

The core commerce facility 136 may include base functions of the e-commerce platform 100 and expose these functions through APIs to applications 142. The APIs may enable different types of applications built through application development 108. Applications 142 may be capable of satisfying a great variety of needs for merchants but may be grouped roughly into three categories: customer-facing applications 216, merchant-facing applications 218, or integration applications 220. Customer-facing applications 216 may include storefront 139 or channels 110 that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 218 may include applications that allow the merchant to administer their storefront 139 (e.g., through applications related to the web or website or to mobile devices), run their business (e.g., through applications related to POS devices 152), to grow their business (e.g., through applications related to shipping (e.g., drop shipping), use of automated agents, use of process flow development and improvements), and the like. Integration applications 220 may include applications that provide useful integrations that participate in the running of a business, such as shipping providers 112 and payment gateways.

In various embodiments, an application developer may use an application proxy to fetch data from an outside location and display it on the page of an online storefront 139. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142 so that the core commerce facility 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110, adds what they intend to buy to their cart, proceeds to checkout, and pays for the content of their cart resulting in the creation of an order for the merchant. The merchant may then view and fulfill (or cancel) the order. The product is then delivered to the customer. If the customer is not satisfied, they might return the products to the merchant.

In an example embodiment, a customer may browse a merchant's products on a channel 110. A channel 110 is a place where customers can view and buy products. In various embodiments, channels 110 may be modeled as applications 142 (a possible exception being the online store 138, which is integrated within the core commence facility 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In various embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., “secret” strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110 may use the core commerce facility 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through the card server environment 148. In various embodiments, the payment gateway 106 may accept international payment, such as integrating with leading international credit card processors. The card server environment 148 may include a card server application, card sink, hosted fields, and the like. This environment may act as the secure gatekeeper of the sensitive credit card information.

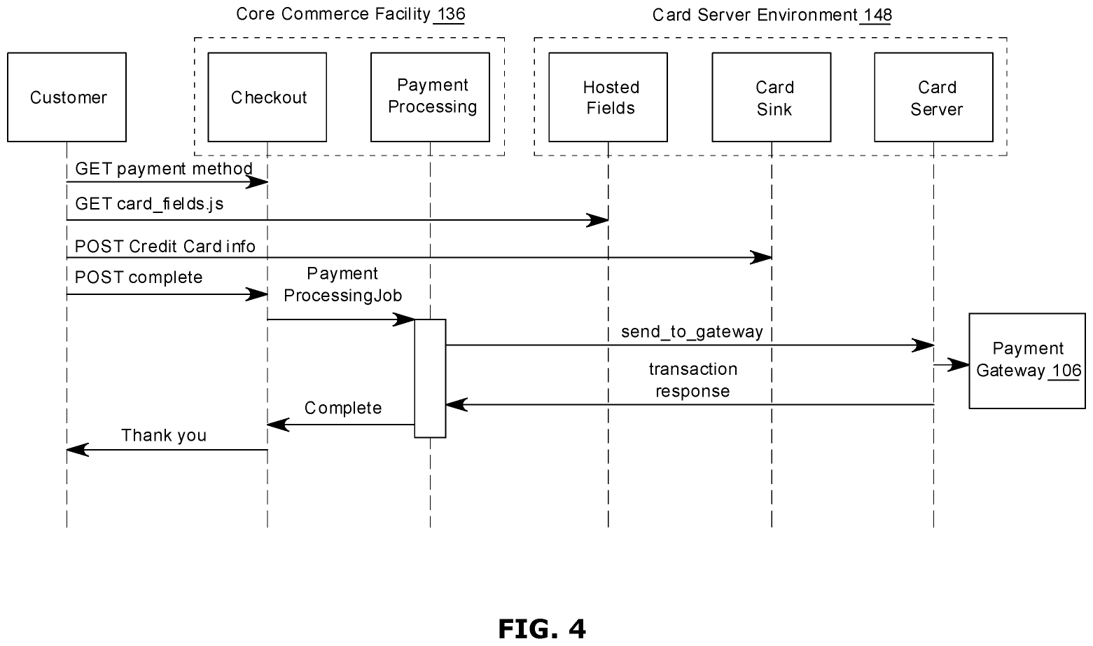

FIG. 4 presents, in a non-limiting example, a simplified sequence diagram of the interactions between the core commerce facility 136 and the card server environment 148 during payment processing of a credit, prepaid, gift or other card on a Web Checkout.

In various embodiments, most of the process may be orchestrated by a payment processing job. The core commerce facility 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110 that do not rely on core commerce facility checkouts may use an order API to create orders. Once an order is created, an order confirmation notification may be sent to the customer and an order placed notification sent to the merchant via a notifications component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor). The merchant may then view and fulfill (or cancel) the order.

An order assessment component may implement a business process merchants use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In various embodiments, this business process may be implemented by a fulfillment component. The fulfillment component may group the line items of the order into a logical fulfillment unit of work based on an inventory location and fulfillment service. The merchant may assess the order, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that does not provide an API connection). An API fulfillment service may trigger a third party, where the third-party application creates a fulfillment record. A legacy fulfillment service may trigger a custom API call from the core commerce facility 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a returns component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that were not returned and remain in the customer's hands); and the like. A return may represent a change to the contract of sale (e.g., the order), and where the e-commerce platform 100 may make the merchant aware of compliance issues with respect to legal obligations (e.g., with respect to taxes). In various embodiments, the e-commerce platform 100 may enable merchants to keep track of changes to the contract of sales over time, such as implemented through a sales model component (e.g., an append-only date-based ledger that records sale-related events that happened to an item).

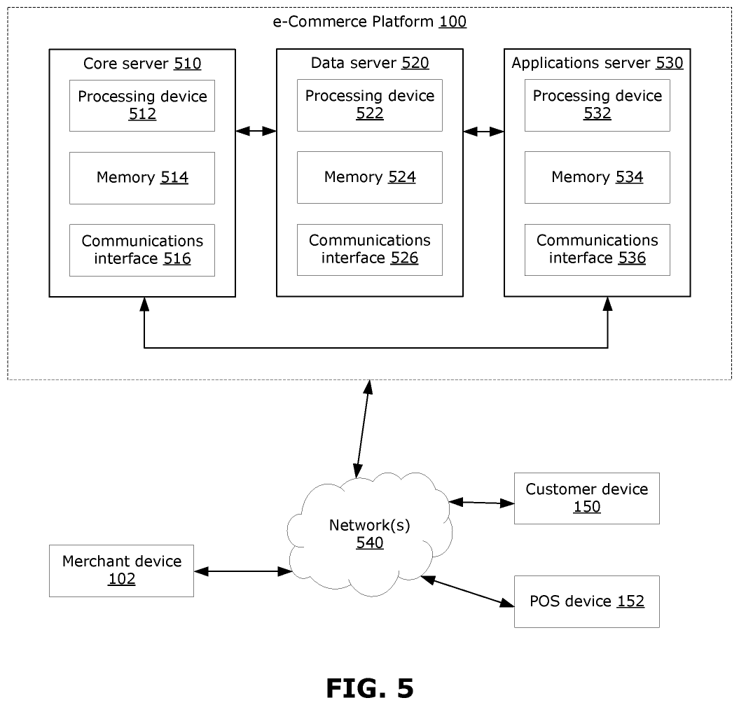

FIG. 5 is a block diagram of an example hardware configuration of the e-commerce platform 100. It should be noted that different components of the e-commerce platform 100 (e.g., the data facility 134, analytics facility 132, core commerce facility 136 and applications 142) may be implemented in separate hardware or software components, on a common hardware component or server or configured as a common (integrated) service or engine in the e-commerce platform 100. In the example of FIG. 5, the e-commerce platform 100 includes a core server 510, a data server 520 and an applications server 530, which are each in communication with each other (e.g., via wired connections and/or via wireless intranet connections). Each of the servers 510, 520, 530 include a respective processing device 512, 522, 532 (each of which may be, for example, a microprocessor, graphical processing unit, digital signal processor or other computational element), a respective memory 514, 524, 534 (each of which may be, for example, random access memory (RAM), read only memory (ROM), hard disk, optical disc, subscriber identity module (SIM) card, memory stick, secure digital (SD) memory card, and the like, and may include tangible or transient memory), and a respective communications interface 516, 526, 536 (each of which may include transmitter, receiver and/or transceiver for wired and/or wireless communications). The core server 510 may store instructions and perform operations relevant to core capabilities of the e-commerce platform, such as providing the administrator 114, analytics 132, core commerce facility 136, services 116 and/or financial facility 130, among others. The data server 520 may be used to implement the data facility 134, among others. The applications server 530 may store instructions and perform operations relevant to the applications 142, such as storing instructions and data for the applications 142 and for implementing application development support 128.

Merchants and customers, using respective devices 102, 150, 152 may access the e-commerce platform 100 via one or more networks 540 (e.g., wired and/or wireless networks, including a virtual private network (VPN), the Internet, and the like).

Although FIG. 5 illustrates an example hardware implementation of the e-commerce platform 100, it should be understood that other implementations may be possible. For example, there may be greater or fewer numbers of servers, the e-commerce platform 100 may be implemented in a distributed manner, or at least some of the memories 514, 524, 534 may be replaced with external storage or cloud-based storage, among other possible modifications.

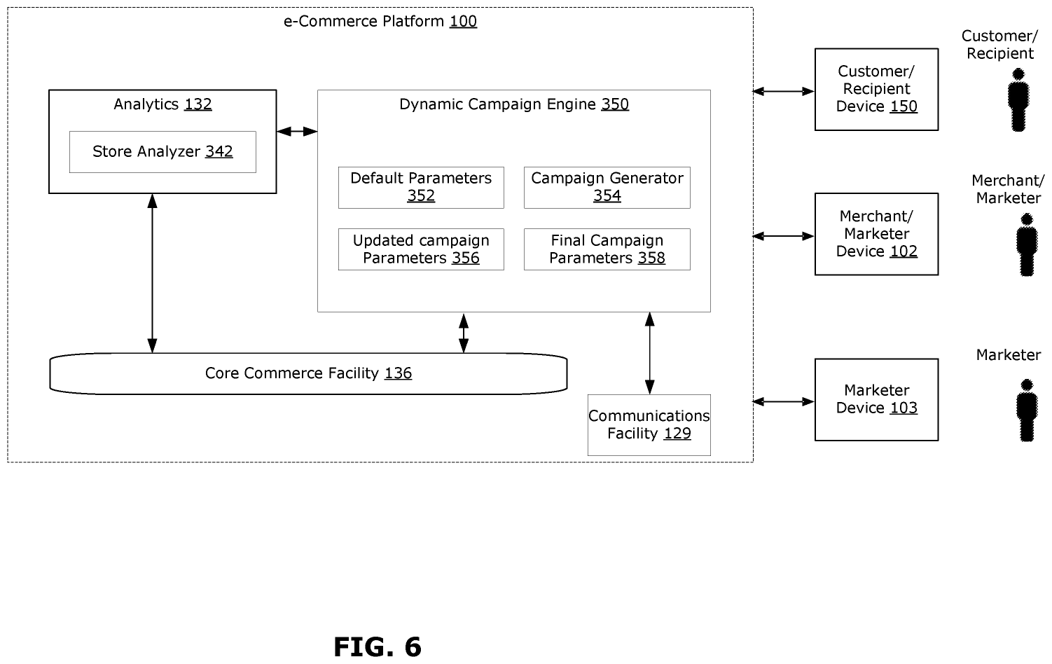

FIG. 6 is another depiction of the e-commerce platform 100 that omits some details that have been described with reference to FIG. 1, and shows further details discussed below. In particular, FIG. 6 illustrates some details of the e-commerce platform 100 that are relevant to dynamically generating and managing a messaging campaign.

In the context of a messaging campaign, a customer of the e-commerce platform 100 may also be a recipient who is an intended recipient of a directed messaging campaign. Accordingly, FIG. 6 illustrates the customer as a customer/recipient, and the customer/recipient may interact with the e-commerce platform 100 via the customer/recipient device 150. However, it should be understood that not all customers of the e-commerce platform 100 may be a recipient of a messaging campaign, and not all recipients of a messaging campaign may be a customer of the e-commerce platform 100. For generality, the present disclosure will refer to “recipients” of a directed messaging campaign. In cases where a recipient is not a current customer of the e-commerce platform 100, the e-commerce platform 100 may nonetheless obtain at least generalized information about the online behavior of the non-customer recipient, for example via anonymized statistical data and/or via user-consented sharing of information with a social media platform, among other possibilities.

In the context of a messaging campaign, a merchant on the e-commerce platform 100 may also be a marketer who is planning a messaging campaign. Accordingly, FIG. 6 illustrates the merchant as a merchant/marketer, and the merchant/marketer may interact with the e-commerce platform via the merchant/marketer device 102. Additionally, a marketer (who is not also a merchant on the e-commerce platform 100) may interact with the e-commerce platform 100 via a marketer device 103. Such a marketer may, for example, use certain services provided by the e-commerce platform 100, such as for generating a messaging campaign as discussed below, without having to be a customer or merchant who is subscribed to the e-commerce platform 100. In some examples, the e-commerce platform 100 may make certain services/applications, such as the dynamic campaign engine 350 discussed below, accessible to users as standalone services/applications.

The analytics facility 132 in this example includes a store analyzer 342, which may be implemented as a sub-module of the analytics facility 132 or may be implemented as part of the general functions of the analytics facility 132. As will be discussed further below, the store analyzer 342 serves to analyze available data of online stores, as well as online behavior of both merchants and customers. In some examples, some or all functions of the store analyzer 342 may be implemented using a machine-learning system.

The e-commerce platform 100 in this example includes a dynamic campaign engine 350. The dynamic campaign engine 350 may be part of the applications 142 or services 116 of the e-commerce platform 100 for example, or may be a standalone component of the e-commerce platform 100. The dynamic campaign engine 350 may, for example, be implemented by the applications server 530 of FIG. 5. In other implementations, the dynamic campaign engine 350 is implemented as a standalone component or service external to the e-commerce platform 100.

In the example of FIG. 6, the dynamic campaign engine 350 includes a campaign generator 354 sub-module. The campaign generator 354 enables automatic generation of one or more sets of campaign parameters for a messaging campaign, as will be discussed further below. The dynamic campaign engine 350 may communicate with the communication facility 129 or another communications interface of the e-commerce platform 100 to enable distribution of messages in accordance with a defined campaign. The dynamic campaign engine 350 in this example also stores messaging campaign-related data, such as default campaign parameters 352, updated campaign parameters 356 and final campaign parameters 358. In some examples, some or all of the messaging campaign-related data, such as default campaign parameters 352, updated campaign parameters 356 and final campaign parameters 358, may be stored outside of the dynamic campaign engine 350, externally to the e-commerce platform 100 or internally, for example in the data facility 134 (see FIG. 1).

A merchant or marketer may engage with the dynamic campaign engine 350 to plan and implement a messaging campaign. For simplicity, the following discussion will refer to a merchant engaging with the dynamic campaign engine 350; however it should be understood that the following discussion may be similarly applicable in the case of a non-merchant marketer instead of a merchant/marketer.

A messaging campaign, in the present disclosure, may be a planned set of messages (which may be marketing messages, in which case the messaging campaign may also be referred to as a marketing campaign) that is communicated to certain intended recipients. In the present disclosure, a messaging campaign (and in particular a marketing campaign) may be associated with an online store (e.g., the online store 138 of the e-commerce platform 100, or an online store that is not part of the e-commerce platform 100) and/or an online merchant.

A messaging campaign may be defined by a set of campaign parameters, such as: maximum number of intended recipients (i.e., campaign size), number of phases of the campaign, number of different messages, a schedule for sending out messages (which may be defined in absolute terms (e.g., specific date(s) and/or time(s)), relative terms (e.g., interval of days between phases of the campaign), conditional terms (e.g., conditional on an intended recipient clicking on a link), etc.), content(s) of messages, permitted incentive inclusion (e.g., a coupon or discount), intended recipients (which may be defined as intended individuals, intended groups, intended demographics, etc.), an intended segment (e.g., age or family status), geographical region of recipients, distribution channel(s) (e.g., email, text message, social network message, etc.), an engagement level of intended recipients (e.g., only those who has previously purchased goods or services, or only those who has browsed the store 138), and a temporal range for the engagement level (e.g., only those who has engaged with the store 138 in the past month or in the past year), among other possible parameters.

A messaging campaign may be conducted over multiple phases. For example, a campaign may be divided into multiple phases based on the schedule. A given recipient may be targeted with multiple messages over the multiple phases of the campaign. For example, a first phase may communicate an initial first message to the given recipient, then according to the schedule a second message (which may have the same content or different content from the first message) may be communicated again to the same given recipient in a second phase of the campaign.

The dynamic campaign engine 350 may generate and store default parameters 352, which may be predefined (e.g., by the e-commerce platform 100). The default parameters 352 are messaging campaign parameters that may be used to generate and carry out a messaging campaign without any user-submitted campaign parameters. In some examples, the default parameters 352 may be general to all merchants using the services of the dynamic campaign engine 350. In some examples, there may be some level of specificity in the default parameters 352, for example there may be different sets of default parameters 352 depending on the size (e.g., as measured by the amount of yearly sales) of the merchant or on the fee tier/subscription level associated with the merchant account.

A merchant may submit a proposed messaging campaign via the merchant device 102, using a user interface (e.g., an online portal) provided by the e-commerce platform 100. A proposed messaging campaign may be submitted by, for example, selecting from available campaign templates that may be populated using the default campaign parameters 352. A proposed messaging campaign may be submitted by only selecting a subset of the required campaign parameters (e.g., submitting only the message content), and the dynamic campaign engine 350 may use default campaign parameters 352 to populate the remaining required campaign parameters. In some examples, a merchant using the services of the dynamic campaign engine 350 may also submit (e.g., via a user interface, such as an online portal provided by the e-commerce platform 100, which may be accessible via a merchant device 102 or marketer device 103) one or more user-submitted campaign parameters for a messaging campaign. The user-submitted campaign parameter(s) may be supplemented by one or more default parameters 352 as appropriate. In some examples, instead of submitting any user-submitted campaign parameters, a merchant may select to use the default parameters 352 to run the messaging campaign.

In some examples, the merchant may not be required to submit any campaign parameters at all. Instead, the e-commerce platform 100 may use information already available (via the e-commerce platform 100's analytics facility 132 for example) about the merchant's online store 138 to automatically generate a default set of parameters for a messaging campaign. For example, the dynamic campaign engine 350 may automatically generate a default set of campaign parameters for a messaging campaign, based on the number of merchant customers, information about the number, type, category and/or inventory of products targeted by the campaign (as determined based on content included in the message(s) such as product descriptions, images), inventory size, etc. of the merchant's online store 138 on the e-commerce platform 100.

The dynamic campaign engine 350 uses the campaign generator 354 to generate a default and/or updated set of parameters for a messaging campaign. For example, the campaign generator 354 may determine that a set of user-submitted campaign parameters should be supplemented by one or more default parameters 352 (e.g., the merchant has not submitted intended recipients, so the campaign generator 354 identifies a default intended demographic from the default parameters 352 and adds this as a parameter for the messaging campaign). As will be discussed further below, the campaign generator 354 may generate default or updated parameters for a messaging campaign, such as recommended distribution channel(s) for certain intended groups (or subgroups). The campaign generator 354 may generate default or updated parameters prior to the start of a messaging campaign, as well as dynamically during the life of the messaging campaign (e.g., generating new parameters for different phases of a campaign). Any default or updated parameter(s) generated by the campaign generator 354 may be notified to a merchant, who may be offered an option to accept or reject the recommended parameter(s). The dynamic campaign engine 350 may compute a final set of campaign parameters 358 based on one or more of: the user-submitted set of campaign parameters, the default set of campaign parameters 352 and the updated set of campaign parameters 356.

After a final set of campaign parameters 358 has been determined by the campaign generator 354, including any recommended parameter(s) that have been offered for merchant approval, the final set of campaign parameters may be stored in the final campaign parameters 358 of the dynamic campaign engine 350. The dynamic campaign engine 350 may store multiple sets of final campaign parameters 358, corresponding to respective multiple messaging campaigns. The final campaign parameters 358 stored by the dynamic campaign engine 350 may be limited to active or ongoing messaging campaigns, or may also include historical or completed messaging campaigns.

The dynamic campaign engine 350 uses the set of final campaign parameters 358 to generate and send messages with the defined message content(s), addressed to the defined intended recipient(s), over the defined distribution channel(s), and according to the defined schedule. In some examples, the dynamic campaign engine 350 may make use of message templates (which may be stored as default parameters 352) to create message content(s). In some examples, the dynamic campaign engine 350 may extract or otherwise obtain information (e.g., product information and/or contact information for individual intended recipients) from the data facility 134 or other database in order to generate the messages. For example, the dynamic campaign engine 350 may use customer information stored in the data facility 134 to identify individuals that belong in the intended group (e.g., a defined demographic, such as a defined age group) defined for a messaging campaign, and generate messages to those individuals using contact information stored in the data facility 134. For privacy and security purposes, the dynamic campaign engine 350 may limit the customer information extracted for a particular merchant campaign to information collected with consent (e.g. by the particular merchant and/or the platform 100) and not make such extracted information available to other merchants or third parties. The dynamic campaign engine 350 may then provide the generated messages to the communications facility 129, which in turn transmits the messages to the intended recipient(s) over the defined distribution channel(s).

The store analyzer 342 serves to analyze available data of one or more online stores 138, as well as online behavior of both merchants and customers, in order to determine if an online store 138 has legitimate configuration data and/or online sales, among other possibilities. The store analyzer 342 can query data facility 134 (FIG. 1) to obtain information regarding a specific online store 138 based on an identification of a merchant. For example, a merchant may have a user account; the user account may have a user identification (ID). The merchant may have one or more online stores 138, and each of the one or more online stores 138 is associated independently with the user ID. Each online store 138 may have a store ID, and has various information stored in the data facility 134 under the store ID. An online store 138 may support one or more independently administered storefronts 139, where a storefront 139 may be represented by a URL; that is, an online store 138 having a store ID may have one or more URLs, with each URL configured for a different storefront 139. All of the URLs under the same store ID may be stored in the data facility 134. A store analyzer 342 may query the data facility 134 to obtain one or more URLs stored under a specific store ID that is linked to a specific user ID of a merchant. An online store 138 may have a number of store configurations and/or customizations in place in order to process transactions. For instance, in order to process a sales transaction, ship and delivery goods or products, receive proceeds of sales from the sales transaction, an online store 138 needs to have a financial transaction configuration in place, including a payment gateway or rail (e.g. credit card, Apple Pay®, PayPal®, etc.), as well as bank deposit information. In addition, the online store 138 needs to have one or more product offerings listed in a storefront 139, and each listed product offering needs to have an inventory count thereof. The financial transaction configuration information, the product offering listings, as well as the individual inventory count for each product offering may be stored in the data facility 134 under a specific store ID and in turn linked to a specific user ID. The online store 138 also should have a delivery configuration set up in place for shipping and delivering the ordered product offerings to the customers. The delivery configuration may include at least a default shipping method (e.g. FedEx®) as well as associated shipping charges. The delivery configuration may be stored in the data facility 134 under a specific store ID and in turn linked to a specific user ID. When the store analyzer 342 queries the data facility 134 based on a user ID of an user account of a merchant, the store analyzer 342 may be able to access a number of information regarding one or more online stores 138 of a specific merchant linked to the user ID, including one or more URLs of the one or more online stores 138, one or more payment rails, one or more bank deposit information, one or more product listings and associated inventory count thereof, and one or more delivery configurations for each online store 138. The more information the store analyzer 134 is able to find, the more legitimate a merchant appears to be.

In various embodiments, online store 138 may support a great number of independently administered storefronts 139 and process a large volume of transactional data on a daily basis for a variety of products. Transactional data may include customer contact information, billing information, shipping information, information on products purchased, information on services rendered, and any other information associated with business through the e-commerce platform 100. In various embodiments, the e-commerce platform 100 may store this data in a data facility 134. The store analyzer 342 may thus further query the data facility 134 to obtain sales volume of one or more product offerings in an online store 138 associated with a specific user ID of a merchant.

In some embodiment, an optional engagement analyzer (not shown) may analyze recipients' engagement with a messaging campaign. The engagement analyzer may analyze engagement over the entire schedule of a messaging campaign, and may also analyze engagement for a defined period of time (e.g., one month) after the end of a messaging campaign. The engagement analyzer may analyze recipients' engagement in an individualized manner and/or in an aggregated manner. For example, if an individual recipient gives permission to access individualized information, the engagement analyzer may analyze how that individual recipient responds (e.g., open or delete a message, click on a link in a message, etc.) to each phase of a given messaging campaign. In another example, the engagement analyzer may analyze engagement in a generalized manner, for example by calculating statistics on the percentage of messages that were read in each phase of a given messaging campaign. Various suitable techniques may be used for individualized or generalized analysis of engagement. The optional engagement analyzer may in some embodiments be part of the store analyzer 342.

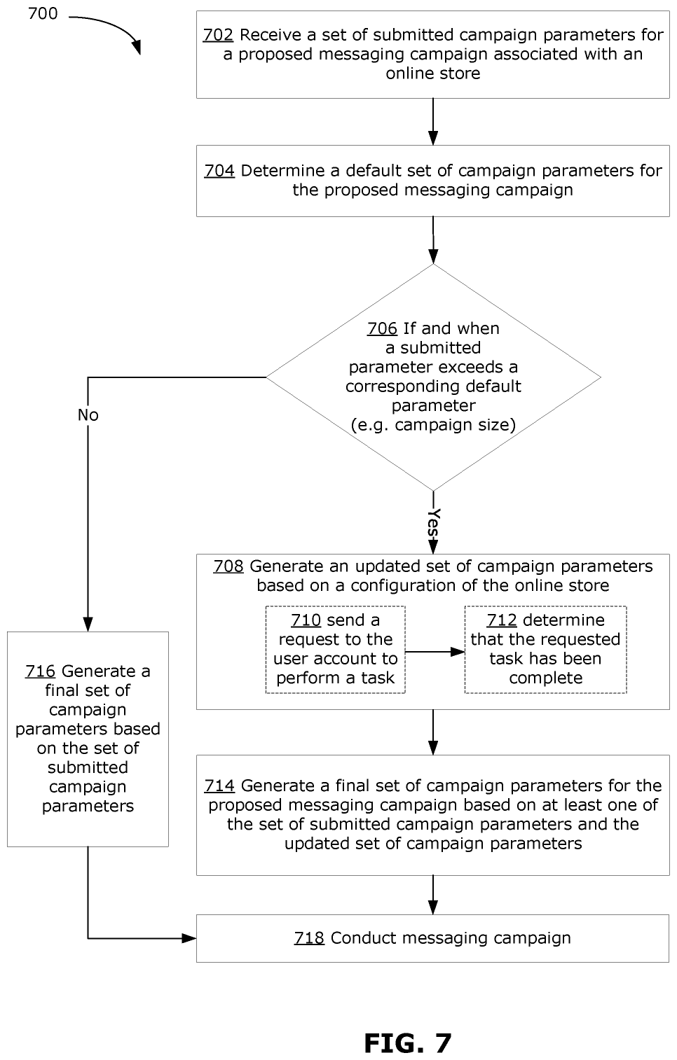

FIG. 7 is a flowchart illustrating an example method 700 for generating a messaging campaign associated with an online store. The method 700 may be implemented by the e-commerce platform 100 (e.g., using the dynamic campaign engine 350 and/or the analytics facility 132). The method 700 may be implemented by a processing device executing instructions (e.g., at the core server 510 or the applications server 530).

At 702, a set of submitted campaign parameters for a proposed messaging campaign associated with an online store 138 may be received, for example from a user account associated with a merchant or marketer via an online user interface provided by the e-commerce platform 100. The set of submitted campaign parameters may include one or more parameters such as: a (maximum) number of intended recipients (i.e., campaign size), number of phases of the campaign, number of different messages, a schedule for sending out messages (which may be defined in absolute terms (e.g., specific date(s) and/or time(s)), relative terms (e.g., interval of days between phases of the campaign), conditional terms (e.g., conditional on an intended recipient clicking on a link), etc.), content(s) of messages, permitted incentive inclusion (e.g., a coupon or discount), intended recipients (which may be defined as intended individuals, intended groups, intended demographics, etc.), an intended segment (e.g., age or family status), geographical region of recipients, and one or more distribution channel(s) (e.g., email, text message, social network message, etc.).

For example, a user at this step may submit a (maximum) number of intended recipients for the campaign, across all distribution channels. A distribution channel is a means of transmitting a message to an intended recipient, such as via e-mail, text message, social network message, or physical mail.

In some embodiments, a set of intended recipients may be identified by recipient identifier (e.g., customer profile ID), recipient contact information (e.g., email address or phone number), demographic group (e.g., certain characteristics such as age, gender, geographical location, etc.), among other possibilities.

A messaging campaign may be conducted over one or multiple phases. For example, a campaign may be divided into multiple phases based on a campaign schedule. A first phase may communicate an initial first message to the given recipient, then according to the schedule, a second message (which may have the same content or a different content from the first message) may be communicated again to the same given recipient in a second phase of the campaign. Each campaign phase may include a maximum of n messages per intended recipient, where n is set to one or more. Often, by default, each phase of a campaign is limited to just one message per intended recipient. A user may set a number of campaign phases per intended recipient, and optionally set a schedule for the campaign phases, which includes when each phase occurs and when a message is sent to an intended recipient.

A campaign duration stipulates how long (e.g. how many days or weeks) a campaign lasts. For example, the user may submit a campaign duration parameter of 10 days. A campaign duration includes all the phases of the campaign. The duration may be set in units of days, weeks, months, or hours. Alternatively, the duration may be set in units of phases as described above.

At 704, a default set of campaign parameters for the proposed messaging campaign are determined, based on one or more factors such as a (marketing) subscription or fee level of the user account of the merchant that has submitted the proposed messaging campaign. One example parameter may be a campaign size of the proposed messaging campaign. For instance, a merchant on the e-commerce platform 100 may pay a subscription fee to run one or more messaging campaigns. With payment of a certain subscription fee, the merchant is recognized as a user who can send messages, via the e-commerce platform 100 (e.g., using dynamic campaign engine 350), up to a fixed number of recipients as part of a messaging campaign. The fixed number of intended recipients may be referred to as a campaign size. At a basic level, the higher the subscription fee, the higher the marketing subscription level of the merchant, and the greater the campaign size of the messaging campaign.

The default set of campaign parameters may also include: number of phases of the campaign, number of different messages, a schedule for sending out messages (which may be defined in absolute terms (e.g., specific date(s) and/or time(s)), relative terms (e.g., interval of days between phases of the campaign), conditional terms (e.g., conditional on an intended recipient clicking on a link), etc.), content(s) of messages, permitted incentive inclusion (e.g., a coupon or discount), intended recipients (which may be defined as intended individuals, intended groups, intended demographics, etc.), an intended segment (e.g., age or family status), geographical region of recipients, one or more distribution channel(s) (e.g., email, text message, social network message, etc.), an engagement level of intended recipients (e.g., only those who has previously purchased goods or services, or only those who has browsed the store 138), and a temporal range for the engagement level (e.g., only those who has engaged with the store 138 in the past month or in the past year).

Other information may be used to populate the default set of campaign parameters, such as a past parameters used in one or more past messaging campaigns launched by the user account.

At 706, the dynamic campaign engine 350 may determine if and when a submitted parameter (e.g., campaign size) from the set of submitted campaign parameters exceeds a corresponding default parameter from the default set of campaign parameters. The user-submitted campaign parameters, if available, may be compared against the default set of campaign parameters generated by the dynamic campaign engine 350, and an updated set of campaign parameters may be generated in view of the comparison at 708. A comparison may be made between, for example, a maximum number of recipients from the user-submitted campaign parameters (“user-submitted campaign size”) and a maximum number of recipients from the default set of campaign parameters (“default campaign size”). If and when the user-submitted campaign size exceeds (e.g., is greater than) the default campaign size, then the dynamic campaign engine 350 may request an updated set of campaign parameters to be generated based on additional factors such as a store configuration of one or more stores 138 of the merchant. For another example, when a user-submitted duration of the campaign (e.g., 10 days) exceeds a default duration of the campaign (e.g., 5 days), then the dynamic campaign engine 350 may request an updated set of campaign parameters to be generated based on additional factors.

In yet another instance, when a user-submitted campaign distribution channel includes both email and text messaging, and the default campaign distribution channel includes only email, then the dynamic campaign engine 350 may request an updated set of campaign parameters to be generated based on additional factors. In some embodiments, when a user-submitted campaign distribution channel includes any distribution channel that is not included in the default campaign distribution channel, then the user-submitted campaign parameter has exceeded the default campaign parameter. In addition or in the alternative, when the number of distribution channels submitted by the user is greater than a maximum number of distribution channels in the default campaign parameters, then the user-submitted campaign parameter has also exceeded the default campaign parameter.

In another example, a user may submit, as a campaign parameter, “2” as a number of phases for a campaign, while the corresponding default campaign parameter is only 1. In this case, the user has submitted a campaign parameter that exceeds the default campaign parameter, and an updated set of campaign parameters should be generated by the dynamic campaign engine 350. If the default maximum number of campaign phases is equal to or greater than the user-submitted number of campaign phases, then the user-submitted campaign parameter has not exceeded the default campaign parameter. Furthermore, if a user has set, in the campaign schedule, a number of messages to be sent (to an intended recipient) in any phase of a campaign, and the number of messages is greater than a maximum number of messages allowed in any given phase of the campaign as set by the default campaign parameters, then the user has submitted a campaign parameter that exceeds the default campaign parameter, and an updated set of campaign parameters should be generated by the dynamic campaign engine 350.

Generally speaking, a user-submitted campaign parameter may be said to “exceed” or “is not compliant with” a default or updated campaign parameter if the user-submitted campaign parameter may cause a greater amount of messages to be sent through the messaging campaign, or otherwise make use of greater amount of resources (e.g., requiring message distribution through more distribution channels) than the default or updated campaign parameter would.

At 708, when the dynamic campaign engine 350 determines that a submitted parameter (e.g., campaign size) from the set of submitted campaign parameters exceeds a corresponding default parameter from the default set of campaign parameters, an updated set of campaign parameters may be generated based on a configuration of the online store.

When a submitted campaign parameter exceeds a corresponding parameter from a default set of campaign parameters, it may signal that the user might be using the campaign generator in bad faith (such a user may be referred to as a “bad actor”) to send spam messages. For example, if the user-submitted campaign size is 2,000 while the default campaign size is only 500, the mismatch may indicate a potential abuse of the campaign generator by the user. In this case, an updated set of campaign parameters is generated in order to prevent bad actors such as illegitimate merchants (e.g. that do not appear to be legitimate sellers) from misusing the e-commerce platform and/or campaign engine 350 for spam campaigns that may or may be related to the content of the online store 138. By generating (and subsequently using) at least some campaign parameters based on a configuration of the online store 138 in cases where potential misuse of the campaign generator is detected, the campaign engine 350 can prevent misuse of the platform and/or campaign engine 350 by bad actors who are not legitimate sellers, as the campaign parameters are generated based on characteristics and features of the online store 138, which is generally difficult for a bad actor to set up simply to send spam messages.

In some embodiments, the campaign generator 354 may generate an updated set of campaign parameters based on (the presence or absence of) one or more configurations of the online store 138, such as payment rail information, valid financial information (e.g., bank deposit information), a custom URL, or a customized storefront. The configurations of the online store 138 may be obtained from store analyzer 342. For example, if the merchant does not appear to have set up any payment rail or bank deposit information for any store, then he is more likely to be a bad actor as compared to merchants who has proper financial information set up. In this case, the merchant without any payment rail or bank deposit information for his store 138 may be permitted to use only a very small campaign size (e.g., 0 to 50 recipients) as a parameter of the proposed messaging campaign.

In some embodiments, the campaign generator 354 may also generate an updated set of campaign parameters based on a user history of the merchant. For example, the system may determine, based on historical data associated with the user account of the merchant, that the merchant has sustained sales activities (e.g., over 100 sale transactions) over a certain period (e.g., a period of 10 months or a year) from one or more online stores 138, and use the maximum number of recipients configured by the system for a messaging campaign based on the sales activities. For another example, the system may determine, based on historical data associated with the user account of the merchant, that the merchant has sustained store activities (e.g., adding product listing, installing a store theme) over a certain period (e.g., a period of 10 months or a year) for one or more online stores 138, and use the maximum number of recipients configured by the system for a messaging campaign based on the store activities. The number of recipients for a messaging campaign can be determined based on historical sales and/or store activity data for a single online store associated with the user account of the merchant, for example, the online store 138 that is the subject of the messaging campaign or multiple online stores 138 (e.g. for a messaging campaign associated with a new online store of the merchant that may have little or no historical data available).

In some embodiments, historical information from previous messaging campaigns run by the same merchant can also be used to generate the updated set of campaign parameters. The recipients' engagement with the previous messaging campaigns may be analyzed, for example, to determine an indication of positive or negative responses to previous messaging campaigns from the same merchant. For example, the number of positive and/or negative responses to a past messaging campaign may be used to determine one or more parameters of the updated set of campaign parameters. Example positive responses may include: opening a message from a campaign, clicking on a link in a campaign email, visiting the online store subsequent to the campaign email, sharing the campaign email, clicking on a product link from a campaign email, purchasing a product from a link included in the campaign email, and so on. Examples of negative responses may include: marking campaign email as spam, not opening the campaign email within a defined time period, deleting the campaign email without opening, and so on. For instance, the greater the positive responses in a historical campaign, the greater the maximum number of recipients as an updated campaign parameter for a proposed campaign.

In some embodiments, at 710, in order to populate one or more parameters in the updated set of campaign parameters, the dynamic campaign engine 350 may send a request to the user account to perform a task. The task may be a store configuration task, e.g. a task specific to setting up the online store 138, or to setting up another online store of the merchant.

For example, the specified task may be configuring the online store 138 for processing transactions, setting up a uniform resource locator (URL) for the online store 138, setting up an inventory configuration for a product offered by the online store 138; setting up delivery configuration for delivering a product offered by the online store 138, setting up a product offering configuration for the online store 138, and/or setting up a financial transaction configuration for the online store 138. Any combination of these tasks, when properly completed, serve to demonstrate that the merchant is a genuine seller of products and/or services, and has a legitimate reason for launching the proposed messaging campaign.

At 712, the dynamic campaign engine 350 can determine if the request to complete a specified task is completed by receiving confirmation from the store analyzer 342 that the specific configuration of the online store 138 is complete (e.g., in place). As described above, the store analyzer 342 can query the data facility 134 in order to access and determine if a merchant with a user ID has one or more online stores 138, and if the one or more online stores 138 have various configurations in place, including one or more URLs of the one or more online stores 138, one or more payment rails or payment gateways, one or more bank deposit information, one or more product listings and associated inventory count thereof, and one or more delivery configurations for each online store 138. The greater amount of information the store analyzer 134 is able to find, the more legitimate a merchant appears to be. The dynamic campaign engine 350 may wait, for a predefined period of time, for the merchant to complete the specified task, and if the merchant has indeed completed the task as requested within the predefined period of time, the dynamic campaign engine 350 may generate the updated set of campaign parameters based on the set of submitted campaign parameters, such as using the user-submitted campaign parameter as an updated campaign parameter, even if the user-submitted campaign parameter has exceeded the corresponding default campaign parameter.

At 714, the dynamic campaign engine 350 can generate a final set of campaign parameters for the proposed messaging campaign based on at least one of the set of submitted campaign parameters and the updated set of campaign parameters. One or more parameters from the updated set of campaign parameters may be used as a final set of campaign parameters for running the messaging campaign. In some embodiments, the final set of campaign parameters may include one or more parameters from the updated set of campaign parameters as well as one or more parameters from the set of submitted campaign parameters.

In some embodiments, when none of the submitted campaign parameters is compliant with the default set of campaign parameters, and the online store 138 has not been configured for processing transactions, the final set of campaign parameters may include some or all parameters from the default set of campaign parameters. For example, if a merchant of the dynamic campaign engine 350 has no online store, or only has an online store that has not yet been set up for processing transactions (e.g. missing payment rail information), and attempts to send messages to a large number of recipients (e.g., 200 recipients) that exceeds the campaign size (e.g., 30 recipients) associated with the subscription level of his user account, the dynamic campaign engine 350 may determine that the merchant is acting in bad faith, and generates a final set of campaign parameters based on a default set of parameters that are determined based on the subscription level of the merchant. In some cases, the dynamic campaign engine 350 may not allow any messaging campaign to be run if the merchant does not have any store set up properly (based on the presence or absence of any store configuration as described above).

In some embodiments, one or more parameters from the set of submitted campaign parameters may exceed the value of a corresponding parameter from the default set of campaign parameters, but the merchant has at least one online store 138 that has been configured properly for selling products and processing transactions. In this case, the final set of campaign parameters may include some or all parameters from the set of submitted campaign parameters. For example, a merchant of the dynamic campaign engine 350 has an online store 138 with proper payment rail as well as bank deposit information set up, and attempts to send messages to a large number of recipients (e.g., 200 recipients) in a messaging campaign. Even though the user-submitted campaign size exceeds the campaign size (e.g., 30 recipients) associated with the subscription level of his user account, the dynamic campaign engine 350 may determine that the merchant is acting in good faith since he has an online store 138 that is set up properly for processing transactions (especially financial transactions), and may generate a final set of campaign parameters based on the user-submitted campaign parameters. The dynamic campaign engine 350 may also determine some parameters of the final set of campaign parameters based on information associated with the online store 138, such as historical sales volume or average daily/weekly/monthly visitor count.

At 716, if all the parameters from the submitted set of campaign parameters are compliant with the default set of campaign parameters, that is, when none of the parameters from the user-submitted campaign parameters exceeds the corresponding parameter from default set of campaign parameters, the final set of campaign parameters may be generated based on the set of submitted campaign parameters alone, without having to generating any updated set of campaign parameters.

At 718, the messaging campaign is conducted (e.g. campaign messages are sent to the intended recipients) using the campaign parameters. In some examples, the messaging campaign is conducted by the dynamic campaign engine 350. In other examples, the dynamic campaign engine 350 may output the campaign parameters to enable the messaging campaign to be conducted by an external system. For example, a marketer may use the dynamic campaign engine 350, as a service provided by the e-commerce platform 100 (or as a stand-alone service provided externally to the e-commerce platform), to better tailor the campaign parameters designed by the marketer's own external campaign system.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

All referenced documents are hereby incorporated by reference in their entireties.

1. A system for a dynamic campaign engine, the system comprising:
a processor in communication with a storage having instructions stored thereon, the processor configured to execute the instructions to cause the system to:
conduct a first messaging campaign associated with an online store, the first messaging campaign being conducted in accordance with a first set of campaign parameters, wherein conducting the first messaging campaign includes causing sending of one or more first campaign messages to respective one or more intended recipients;
receive, from a user account, a set of submitted campaign parameters for a second proposed messaging campaign associated with the online store;
determine a default set of campaign parameters for the second proposed messaging campaign, the default set of campaign parameters being at least partly dependent on positive or negative responses of the one or more intended recipients to the conducted first messaging campaign;
determine that at least one parameter from the set of submitted campaign parameters exceeds a corresponding parameter from the default set of campaign parameters;
responsive to determining that at least one parameter from the set of submitted campaign parameters exceeds the corresponding parameter from the default set of campaign parameters, generate an updated set of campaign parameters based on a configuration of the online store;
generate a final set of campaign parameters for the second proposed messaging campaign using the updated set of campaign parameters; and
conduct the second proposed messaging campaign in accordance with the final set of campaign parameters.

2. The system of claim 1, wherein the processor is further configured to execute the instructions to cause the system to determine the default set of campaign parameters based on a subscription level of the user account.

3. (canceled)

4. The system of claim 1, wherein the processor is further configured to execute the instructions to cause the system to:
determine that none of the set of submitted campaign parameters are compliant with the default set of campaign parameters and the online store has not been configured for processing transactions; and
responsive to determining that none of the set of submitted campaign parameters are compliant with the default set of campaign parameters and the online store has not been configured for processing transactions, generate the final set of campaign parameters using some or all parameters from the default set of campaign parameters as the updated set of campaign parameters.

5. The system of claim 1, wherein the processor is further configured to execute the instructions to cause the system to:
determine that the online store has been configured for processing transactions; and
responsive to determining that the online store has been configured for processing transactions, generate the final set of campaign parameters using some or all parameters from the set of submitted campaign parameters as the updated set of campaign parameters.

6. The system of claim 1, wherein the processor is further configured to execute the instructions to cause the system to:
determine that the online store has been configured for processing transactions; and
responsive to determining that the online store has been configured for processing transactions, generate the updated set of campaign parameters based on a financial transaction configuration for the online store.

7. The system of claim 1, wherein the configuration for the online store comprises at least one of: a uniform resource locator (URL) for the online store; an inventory configuration for a product offered by the online store; a delivery configuration for delivering a product offered by the online store; a product offering configuration for the online store; and a financial transaction configuration for the online store.

8. The system of claim 1, wherein the processor is further configured to execute the instructions to cause the system to generate the updated set of campaign parameters based on a transaction history of the online store.

9. The system of claim 1, wherein the final set of campaign parameters comprises at least one of: a campaign distribution channel; a maximum number of recipients; an intended segment; a campaign message format; a permitted incentive inclusion; a geographical region of recipients; and a duration of a campaign.

10. The system of claim 1, wherein the processor is further configured to execute the instructions to cause the system to, responsive to determining that the at least one parameter from the set of submitted campaign parameters exceeds the corresponding parameter from the default set of campaign parameters:
send a request to the user account to perform a task;
determine that the requested task has been completed; and
generate the updated set of campaign parameters based on the set of submitted campaign parameters.

11. The system of claim 10, wherein the task comprises at least one of: configuring the online store for processing transactions; setting up a uniform resource locator (URL) for the online store; setting up delivery configuration for delivering a product offered by the online store; setting up a product offering configuration for the online store; and setting up a financial transaction configuration for the online store.

12. A computer-implemented method for dynamically executing a messaging campaign, the method comprising:
conducting a first messaging campaign associated with an online store, the first messaging campaign being conducted in accordance with a first set of campaign parameters, wherein conducting the first messaging campaign includes causing sending of one or more first campaign messages to respective one or more intended recipients;
receiving, from a user account, a set of submitted campaign parameters for a second proposed messaging campaign associated with the online store;
determining a default set of campaign parameters for the second proposed messaging campaign, the default set of campaign parameters being at least partly dependent on positive or negative responses of the one or more intended recipients to the conducted first messaging campaign;
determining that at least one parameter from the set of submitted campaign parameters exceeds a corresponding parameter from the default set of campaign parameters;
responsive to determining that at least one parameter from the set of submitted campaign parameters exceeds the corresponding parameter from the default set of campaign parameters, generating an updated set of campaign parameters based on a configuration of the online store;
generating a final set of campaign parameters for the second proposed messaging campaign using the updated set of campaign parameters; and
conducting the second proposed messaging campaign in accordance with the final set of campaign parameters.

13. The method of claim 12, further comprising determining the default set of campaign parameters based on a subscription level of the user account.

14. (canceled)

15. The method of claim 12, further comprising:
determining that none of the set of submitted campaign parameters are compliant with the default set of campaign parameters and the online store has not been configured for processing transactions; and
responsive to determining that none of the set of submitted campaign parameters are compliant with the default set of campaign parameters and the online store has not been configured for processing transactions, generating the final set of campaign parameters using some or all parameters from the default set of campaign parameters as the updated set of campaign parameters.

16. The method of claim 12, further comprising:
determining that the online store has been configured for processing transactions; and
responsive to determining that the online store has been configured for processing transactions, generating the final set of campaign parameters using some or all parameters from the set of submitted campaign parameters as the updated set of campaign parameters.

17. The method of claim 12, further comprising:
determining that the online store has been configured for processing transactions; and
responsive to determining that the online store has been configured for processing transactions, generating the updated set of campaign parameters based on a financial transaction configuration for the online store.

18. The method of claim 12, wherein the configuration for the online store comprises at least one of: a uniform resource locator (URL) for the online store; delivery configuration for delivering a product offered by the online store; a product offering configuration for the online store; and a financial transaction configuration for the online store.

19. The method of claim 12, further comprising generating the updated set of campaign parameters based on a transaction history of the online store.

20. The method of claim 12, wherein the final set of campaign parameters comprises at least one of: a campaign distribution channel; a maximum number of recipients; an intended segment; a campaign message format; a permitted incentive inclusion; a geographical region of recipients; and a duration of a campaign.

21. The method of claim 12, further comprising:
responsive to determining that the at least one parameter from the set of submitted campaign parameters exceeds the corresponding parameter from the default set of campaign parameters:
sending a request to the user account to perform a task;
determining that the requested task has been completed; and
generating the updated set of campaign parameters based on the set of submitted campaign parameters.

22. The method of claim 21, wherein the task comprises at least one of: configuring the online store for processing transactions; setting up a uniform resource locator (URL) for the online store; setting up delivery configuration for delivering a product offered by the online store; setting up a product offering configuration for the online store; and setting up a financial transaction configuration for the online store.

23. A non-transitory computer readable medium having computer-executable instructions stored thereon, wherein the instructions, when executed by a processor of a system, cause the system to:
conduct a first messaging campaign associated with an online store, the first messaging campaign being conducted in accordance with a first set of campaign parameters, wherein conducting the first messaging campaign includes causing sending of one or more first campaign messages to respective one or more intended recipients;
receive, from a user account, a set of submitted campaign parameters for a second proposed messaging campaign associated with the online store;
determine a default set of campaign parameters for the second proposed messaging campaign, the default set of campaign parameters being at least partly dependent on positive or negative responses of the one or more intended recipients to the conducted first messaging campaign;
determine that at least one parameter from the set of submitted campaign parameters exceeds a corresponding parameter from the default set of campaign parameters;
responsive to determining that at least one parameter from the set of submitted campaign parameters exceeds the corresponding parameter from the default set of campaign parameters, generate an updated set of campaign parameters based on a configuration of the online store;
generate a final set of campaign parameters for the second proposed messaging campaign using the updated set of campaign parameters; and
conduct the second proposed messaging campaign in accordance with the final set of campaign parameters.

24. The non-transitory computer readable medium of claim 23, wherein instructions, when executed, further cause the system to:
determine that the online store has been configured for processing transactions; and
responsive to determining that the online store has been configured for processing transactions, generate the updated set of campaign parameters based on a financial transaction configuration for the online store.

25. The non-transitory computer readable medium of claim 23, wherein instructions, when executed, further cause the system to, responsive to determining that the at least one parameter from the set of submitted campaign parameters exceeds the corresponding parameter from the default set of campaign parameters:
send a request to the user account to perform a task;
determine that the requested task has been completed; and
generate the updated set of campaign parameters based on the set of submitted campaign parameters.
